(19) United States
(12) Patent Application Publication
(10) Pub. No.: US 2025/0154084 A1
(43) Pub. Date: May 15, 2025

(54) NOVEL UNSATURATED HYDROBROMOFLUOROCARBON FIRE SUPPRESSANTS

(71) Applicant: Kidde Graviner Limited, Shirley (GB)

(72) Inventors: Adam Chattaway, Windsor (GB); Paul Papas, West Hartford, CT (US); Andrew Spaeth, Holden, MA (US)

(21) Appl. No.: 18/510,022

(22) Filed: Nov. 15, 2023

(51) Int. Cl. C07C 21/18; A62C 3/07

(52) U.S. Cl. CPC C07C 21/18; A62C 3/07

(57) ABSTRACT

The present disclosure relates to a fire suppression composition comprising a hydrobromofluoroalkene compound of formula CₙX₂ₙ, where: n is an integer from 2 to 6; each X is independently selected from the group consisting of Br, F, Cl and H, provided at least one X is Br; and the compound does not contain —CF₃ or —CF_{2—.}

### TECHNICAL FIELD

The present disclosure relates to fire suppression compositions and compounds, fire suppression devices, a method of suppressing a fire, and a method for preparing the fire suppression compounds and compositions.

### BACKGROUND

Halon 1301 (bromotrifluoromethane, CF₃Br) has frequently been employed as a fire suppression agent. Its uses include as an agent in enclosed-area fire suppression systems, such as those commonly used in aircraft, e.g. in the cargo compartment and the engine/APU. However, production of Halon 1301 was banned in 1994 due to its high ozone depleting potential. Since then, a number of fire suppression sectors (including, but not limited, to aviation) have been relying on the bank of recovered/recycled Halon 1301. This bank of recycled agent is nearing depletion; consequently, the long-standing desire to replace Halon 1301 with more environmentally-friendly fire suppression agents is becoming more urgent.

A number of replacements for Halon 1301 have been suggested, including various combinations of inert gas and water mist, and hydrofluorocarbons (HFCs). However, these combinations are not as efficient as Halon 1301.

Combinations of water mist and an inert gas, such as nitrogen, are environmentally-friendly, but are relatively inefficient fire extinguishing agents, requiring relatively larger quantities than Halon 1301. Furthermore, the resulting size and weight of the fire protection system required for these agents has been deemed unacceptable for many applications.

More recently, a more efficient fire suppression agent, 2-bromo-3,3,3-trifluoropropene (2-BTP) has been developed and commercialised. Like Halon 1301, 2-BTP also contains a bromine atom, which means it has the ability to catalytically inhibit important chain reactions occurring in flames. For this reason, 2-BTP is one of the most efficient Halon replacements identified thus far.

Many fluorinated fire suppressants, including 2-BTP, are classed, however, as polyfluoro-alkyl substances (PFAS) under at least one definition of PFAS. Under this definition, PFAS are molecules which contain at least one fully-fluorinated saturated carbon atom (i.e. a —CF2— and/or —CF3 group). Many PFAS are persistent, bioaccumulative and toxic. These characteristics have led to a proposal to ban PFAS for environmental reasons. If this proposal is adopted, the use of PFAS as fire suppressants will be banned in the EU.

Accordingly, a solution is needed that would provide environmentally-friendly, yet effective, alternative fire suppression agents which can replace PFAS. The present disclosure addresses this need.

### SUMMARY

The inventors have identified alternatives to Halon 1301 and PFAS such as 2-BTP, and propose alternative fire suppressants which are more environmentally-friendly, and will not be subject to the proposed ban. In view of this, the compounds and compositions herein described offer a suitable replacement for PFAS fire suppressants.

According to a first aspect, this disclosure provides non-PFAS hydrobromofluoroalkenes as fire suppressant compounds. The disclosure also provides a fire suppression composition comprising a non-PFAS hydrobromofluoroalkene, i.e. a hydrobromofluoroalkene which contains no —CF2— or —CF3 groups.

According to a further aspect, the present disclosure also provides a fire suppression system or device, e.g. a fire extinguisher, fire suppression device, or storage device, wherein the system or device comprises a fire suppression composition or compound as herein described.

Also disclosed is a method for extinguishing or suppressing a fire comprising using (e.g. dispensing) a fire suppression composition or compound as herein described.

According to a further aspect, the present disclosure also provides use of a compound or composition as herein described as a fire suppressant.

The present disclosure also provides compounds as herein described and methods for their preparation.

According to a further aspect, the present disclosure also provides a hydrobromofluoroalkene which contains no —CF2— or —CF3 groups.

According to a further aspect, the present disclosure also provides a non-PFAS hydrobromofluoroalkene, e.g. a compound of formula CₙX₂ₙ, wherein:
n=2-6;
each X is independently selected from the group consisting of Br, F, Cl and H; and
the compound does not contain —CF₃ or —CF₂—.

Compositions, e.g., fire suppressant compositions, comprising the compounds of the present disclosure in combination with other fire suppressant agents, e.g. such as carbon dioxide and/or nitrogen, are also disclosed.

### DETAILED DESCRIPTION

The hydrobromofluoroalkene compounds and compositions proposed are more efficient fire suppressants than nitrogen alone, and have the additional benefit that they can be partially stored as a liquid. This has the advantage of reducing the weight and volume compared to traditional inert gas systems. Although not wishing to be bound by theory, the hydrobromofluoroalkene compounds proposed are expected to possess suitable fire suppressant ability due to the presence of bromine, but be more environmentally-friendly than current options due to the lack of fully-fluorinated saturated carbon atoms and the double bond, which shortens atmospheric lifetime and promotes tropodegradable behaviour. The disclosed approach thus eliminates the use of Halon 1301 and PFAS fire suppressants and replaces them with efficient, yet environmentally-friendly, fire suppression agents, namely non-PFAS hydrobromofluoroalkenes.

Polyfluoro-alkyl substances (PFAS) are compounds containing at least one fully-fluorinated saturated carbon atom, i.e. compounds containing the group “—CF2—”, or the group “A-CF3” (unless A is N, F, Cl, Br or H).

Non-PFAS compounds therefore may contain ═CF₂ or C(F)═C, but lack the following moieties:
A-CF₃ (unless A is N, F, Cl, Br or H) and
—CF₂—.

The fire suppression composition of the present disclosure may comprise one or more non-PFAS hydrobromofluoralkenes as herein described. The composition may comprise mixtures of isomers of the same compound, and/or mixtures of different compounds as herein described.

The fire suppression compositions and compounds of the present disclosure comprise, or are, non-PFAS hydrobromofluoroalkenes, i.e. hydrobromofluoroalkenes which contain no —CF2— or —CF3 groups. In other words, each saturated carbon atom must be bonded to at least one non-F atom, e.g. H or Br.

The present disclosure also provides the non-PFAS hydrobromofluoroalkenes as fire suppressants.

In some embodiments, the compounds, i.e. the non-PFAS hydrobromofluoroalkenes, according to the present disclosure are compounds of formula CₙX₂ₙ, wherein:
n is an integer from 2 to 6;
each X is independently selected from the group consisting of Br, F, Cl and H, provided at least one X is Br; and
the compound does not contain —CF₃ or —CF₂—.

The compositions comprise one or more of the above compounds and any combinations thereof.

In some embodiments, the alkene is substituted by Br, F, Cl and H, e.g. each X is independently selected from the group consisting of Br, F, Cl and H. In some embodiments, the compound contains no Cl, e.g. the alkene is substituted by Br, F, and H, e.g. only by Br, F and H, i.e. each X is independently selected from the group consisting of Br, F and H.

At least 1, e.g. 1, 2 or 3, X is Br. In some embodiments, the compound comprises 1-3 bromine atoms.

In some embodiments, n=3-5, e.g. 3 or 4, i.e. the alkene is a hydrobromofluoro-propene, -butene, -pentene or -hexene, e.g. a hydrobromofluoro-propene or -butene.

In some embodiments, the number of F atoms is an integer from 1 to 8, e.g. 2 to 8, e.g. 3 to 6. In some embodiments, at least 1, e.g. 1-8, or 3-6, X is F. In some embodiments, the number of F atoms in the compound is greater than or equal to the number of C atoms. In some embodiments, the number of F atoms is an integer from n−1 to n+4, e.g. from n to n+2.

In some embodiments, the number of F atoms in the compound is greater than or equal to the number of H atoms.

—CF2— denotes a saturated carbon atom which is substituted by two fluorine atoms, i.e. the following:

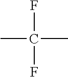

The compounds of the present disclosure may comprise a C═CF2 group or a C(F)═C group.

The fire suppression composition may comprise one or more non-PFAS hydrobromofluoroalkene compounds as herein described.

The one or more compounds may be selected from the group consisting of non-PFAS isomers of trifluorobromopropene, tetrafluorobromopropene, pentafluorobromopropene, bromotetrafluorobutene, bromopentafluorobutene, bromohexafluorobutene, hydrobromofluoropentene, hydrobromofluorohexene and any combinations thereof.

The one or more compounds may be selected from the group consisting of non-PFAS isomers of trifluorobromopropene, tetrafluorobromopropene, bromotetrafluorobutene, bromopentafluorobutene, bromohexafluorobutene, hydrobromofluoropentene, hydrobromofluorohexene and any combinations thereof.

Examples of suitable trifluorobromopropenes include the following and any combinations thereof:
E/Z-1-bromo-1,3,3-trifluoropropene, i.e. CF₂HCH═CBrF
E/Z-1-bromo-2,3,3-trifluoropropene, i.e. CF₂HCF═CHBr
2-bromo-1,1,3-trifluoropropene, i.e. CFH₂CBr═CF₂
E/Z-2-bromo-1,3,3-trifluoropropene, i.e. CF₂HCBr═CHF
3-bromo-1,1,2-trifluoropropene, i.e. CH₂BrCF═CF₂
E/Z-3-bromo-1,2,3-trifluoropropene, i.e. CHBrFCF═CHF
3-bromo-2,3,3-trifluoropropene, i.e. CF₂BrCF═CH₂
E/Z-3-bromo-1,3,3-trifluoropropene, i.e. CF₂BrCH═CHF
E/Z-1-bromo-1,2,3-trifluoropropene, i.e. CFH₂CF═CBrF
3-bromo-1,1,3-trifluoropropene, i.e. CFHBrCH═CF₂

In some embodiments, the trifluorobromopropenes include the following and any combinations thereof:
2-bromo-1,1,3-trifluoropropene, i.e. CFH₂CBr═CF₂
3-bromo-1,1,2-trifluoropropene, i.e. CH₂BrCF═CF₂
E/Z-3-bromo-1,2,3-trifluoropropene, i.e. CHBrFCF═CHF
3-bromo-2,3,3-trifluoropropene, i.e. CF₂BrCF═CH₂
E/Z-3-bromo-1,3,3-trifluoropropene, i.e. CF₂BrCH═CHF
E/Z-1-bromo-1,2,3-trifluoropropene, i.e. CFH₂CF═CBrF
3-bromo-1,1,3-trifluoropropene, i.e. CFHBrCH═CF₂

In some embodiments, the trifluorobromopropenes include the following and any combinations thereof:
2-bromo-1,1,3-trifluoropropene, i.e. CFH₂CBr═CF₂
E/Z-3-bromo-1,2,3-trifluoropropene, i.e. CHBrFCF═CHF
E/Z-1-bromo-1,2,3-trifluoropropene, i.e. CFH₂CF═CBrF
3-bromo-1,1,3-trifluoropropene, i.e. CFHBrCH═CF₂

Examples of suitable tetrafluorobromopropenes include the following and any combinations thereof:
E/Z-1-bromo-1,2,3,3-tetrafluoropropene, i.e. CF₂HCF═CBrF
2-bromo-1,1,3,3-tetrafluoropropene, i.e. CHF₂CBr═CF₂
3-bromo-1,1,2,3-tetrafluoropropene, i.e. CHFBrCF═CF₂
3-bromo-1,1,3,3-tetrafluoropropene, i.e. CF₂BrCH═CF₂
E/Z-3-bromo-1,2,3,3-tetrafluoropropene, i.e. CF₂BrCF═CHF

In some embodiments, the tetrafluorobromopropenes include the following and any combinations thereof:
E/Z-1-bromo-1,2,3,3-tetrafluoropropene, i.e. CF₂HCF═CBrF
2-bromo-1,1,3,3-tetrafluoropropene, i.e. CHF₂CBr═CF₂
3-bromo-1,1,2,3-tetrafluoropropene, i.e. CHFBrCF═CF₂
E/Z-3-bromo-1,2,3,3-tetrafluoropropene, i.e. CF₂BrCF═CHF

Examples of suitable bromotetrafluorobutenes include the following and any combinations thereof:
E/Z-1-bromo-2,3,4,4-tetrafluorobut-1-ene, i.e. CHF₂CHFCF═CHBr
E/Z-1-bromo-1,3,4,4-tetrafluorobut-1-ene, i.e. CHF₂CHFCH═CFBr
E/Z-1-bromo-1,2,4,4-tetrafluorobut-1-ene, i.e. CHF₂CH2CF═CFBr
E/Z-1-bromo-1,2,3,4-tetrafluorobut-1-ene, i.e. CH₂FCHFCF═CFBr
E/Z-2-bromo-1,3,4,4-tetrafluorobut-1-ene, i.e. CHF₂CHFCBr═CHF
2-bromo-1,1,4,4-tetrafluorobut-1-ene, i.e. CHF₂CH₂CBr═CF₂
2-bromo-1,1,3,4-tetrafluorobut-1-ene, i.e. CH₂FCHFCBr═CF₂
3-bromo-2,3,4,4-tetrafluorobut-1-ene, i.e. CHF₂CFBrCF═CH₂
E/Z-3-bromo-1,3,4,4-tetrafluorobut-1-ene, i.e. CHF₂CFBrCH═CHF
3-bromo-1,2,4,4-tetrafluorobut-1-ene, i.e. CHF₂CFBrCF═CH₂
E/Z-3-bromo-1,2,3,4-tetrafluorobut-1-ene, i.e. CH₂FCFBrCF═CHF
3-bromo-1,1,3,4-tetrafluorobut-1-ene, i.e. CHF₂CHBrCH═CF₂
4-bromo-2,3,4,4-tetrafluorobut-1-ene, i.e. CF₂BrCHFCF═CH₂
E/Z-4-bromo-1,3,4,4-tetrafluorobut-1-ene, i.e. CF₂BrCHFCH═CHF
4-bromo-1,1,4,4-tetrafluorobut-1-ene, i.e. CF₂BrCH₂CH═CF₂
E/Z-4-bromo-1,2,3,4-tetrafluorobut-1-ene, i.e. CHFBrCHFCF═CHF
4-bromo-1,1,3,4-tetrafluorobut-1-ene, i.e. CHFBrCHFCH═CF₂
E/Z-1-bromo-1,1,2,3-tetrafluorobut-2-ene, i.e. CF₂BrCF═CFCH₃
E/Z-1-bromo-1,1,2,4-tetrafluorobut-2-ene, i.e. CF₂BrCF═CHCH₂F
E/Z-1-bromo-1,1,3,4-tetrafluorobut-2-ene, i.e. CF₂BrCH═CFCH₂F
E/Z-1-bromo-1,2,3,4-tetrafluorobut-2-ene, i.e. CHFBrCH═CFCH₂F
E/Z-1-bromo-1,1,4,4-tetrafluorobut-2-ene, i.e. CF₂BrCH═CHCHF₂
E/Z-1-bromo-1,2,4,4-tetrafluorobut-2-ene, i.e. CHFBrCF═CHCHF₂
E/Z-1-bromo-1,1,4,4-tetrafluorobut-2-ene, i.e. CHFBrCH═CHCHF₂
E/Z-1-bromo-2,3,4,4-tetrafluorobut-2-ene, i.e. CH₂BrCF═CFCHF₂
E/Z-2-bromo-1,3,4,4-tetrafluorobut-2-ene, i.e. CH₂FrCBr═CFCHF₂
E/Z-2-bromo-1,1,3,4-tetrafluorobut-2-ene, i.e. CHF₂CBr═CFCH₂F
E/Z-2-bromo-1,1,4,4-tetrafluorobut-2-ene, i.e. CHF₂CBr═CHCHF₂
E/Z-3-bromo-1,3-difluoro-2-(fluoromethyl)butene, i.e. CHF═C(CHF₂)CHFBr
3-bromo-1,1,3-trifluoro-2-(fluoromethyl)butene, i.e. CF₂═C(CH₂F)CHFBr
3-bromo-1,1,3,3-tetrafluoro-2-(methyl)butene, i.e. CF₂═C(CH₃)CF₂Br
3-bromo-3,3-difluoro-2-(difluoromethyl)butene, i.e. CH₂═C(CHF₂)CF₂Br
E/Z-1-bromo-1,3-difluoro-2-(difluoromethyl)butene, i.e. CFBrC(CHF₂)CH₂F
E/Z-1-bromo-3,3-difluoro-2-(difluoromethyl)butene, i.e. CHBr═C(CHF₂) CHF₂

Examples of suitable bromopentafluorobutenes include the following and any combinations thereof:
E/Z-1-bromo-1,2,3,4,4-pentafluorobut-1-ene, i.e. CHF₂CHFCF═CFBr
2-bromo-1,1,3,4,4-pentafluorobut-1-ene, i.e. CF₂HCHFCBr═CF₂
3-bromo-1,1,2,3,4-pentafluorobut-1-ene, i.e. CH₂FCFBrFCF═CF₂
3-bromo-1,1,2,4,4-pentafluorobut-1-ene, i.e. CHF₂CHBrCF═CF₂
3-bromo-1,1,3,4,4-pentafluorobut-1-ene, i.e. CHF₂CFBrCH═CF₂
E/Z-3-bromo-1,2,3,4,4-pentafluorobut-1-ene, i.e. CHF₂CFBrCF═CHF
4-bromo-1,1,2,3,4-pentafluorobut-1-ene, i.e. CHFBrCHFCF═CF₂
4-bromo-1,1,2,4,4-pentafluorobut-1-ene, i.e. CF₂BrCH2CF═CF₂
4-bromo-1,1,3,4,4-pentafluorobut-1-ene, i.e. CF₂BrCHFCH═CF₂
E/Z-4-bromo-1,1,2,3,4-pentafluorobut-1-ene, i.e. CF₂BrCHFCF═CHF
E/Z-1-bromo-1,1,2,3,4-pentafluorobut-2-ene, i.e. CF₂BrCF═CFCH₂F
E/Z-1-bromo-1,1,2,4,4-pentafluorobut-2-ene, i.e. CF₂BrCF═CHCHF₂
E/Z-1-bromo-1,1,3,4,4-pentafluorobut-2-ene, i.e. CF₂BrCH═CFCHF₂
E/Z-1-bromo-1,2,3,4,4-pentafluorobut-2-ene, i.e. CHFBrCF═CFCHF₂
E/Z-2-bromo-1,1,3,4,4-pentafluorobut-2-ene, i.e. CHF₂CBr═CFCHF₂
3-bromo-1,1,3,3-tetrafluoro-2-(fluoromethyl)butene, i.e. CF₂═C(CH₂F)CF₂Br
3-bromo-1,1,3-trifluoro-2-(difluoromethyl)butene, i.e. CF₂═C(CHF₂)CHFBr
E/Z-3-bromo-1,3,3-trifluoro-2-(difluoromethyl)butene, i.e. CHF═C(CHF₂)CF₂Br
E/Z-1-bromo-1,3,3-trifluoro-2-(difluoromethyl)butene, i.e. CFBr═C(CHF₂)CHF₂

Examples of suitable bromohexafluorobutenes include the following and any combinations thereof:
E/Z-1-bromo-1,1,2,3,4,4-hexafluorobut-2-ene, i.e. CF₂BrCF═CFCHF₂
4-bromo-1,1,2,3,4,4-hexafluorobut-1-ene, i.e. CF₂BrCHFCF═CF₂
3-bromo-1,1,2,3,4,4-hexafluorobut-1-ene, i.e. CF₂HCBrFCF═CF₂
3-bromo-1,1,3,3-tetrafluoro-2-(difluoromethyl)butene, i.e. CF₂═C(CHF₂)CF₂Br

In some embodiments, the hydrobromofluoroalkene according to the present disclosure is a hydrobromofluoropropene or a hydrobromofluorobutene.

In some embodiments, the hydrobromofluoroalkene according to the present disclosure is a trifluorobromopropene or a tetrafluorobromopropene.

The fire extinguishing performance of the non-PFAS compounds disclosed herein may be due to a number of factors. Fire extinguishing performance is made up of contributions from the catalytic aspect of the bromine atom (often referred to as the “chemical contribution”) and the heat capacity of the molecule (often referred to as the “physical contribution”).

Halogen atoms such as Br act as homogenous catalysts in reducing the H atom concentration necessary for the chain branching reaction sequence in flames. The expected chemical suppression, between compounds with the same number of bromine atoms, will be similar, and will increase with increasing number of bromine atoms. The location of the Br atom (whether bonded to a vinylic or allylic carbon) and molecular structure may lead to variations in chemical suppression effectiveness, however, these variations for isomers for a given chemical compound family (e.g. bromotrifluoropropenes that are not “PFAS”) are not expected to be significant.

Therefore, any variation in fire extinguishing performance will depend mainly on the different heat capacities, with higher heat capacities leading to lower agent concentration for suppressing or extinguishing flames. Detailed evaluations to determine the suppression agent concentration can be performed using high-fidelity computer simulations for laminar flames incorporating detailed chemical kinetic mechanisms, thermodynamic and transport descriptions. Such techniques are known in the art.

Fire suppression activity of hydrobromofluoropropenes with a single Br atom may be compared to the commercially available 2-BTP, and those with a greater number of bromine atoms will be superior. For example, it is reasonable to assume that the overall suppression effectiveness for the various structural isomers of bromotrifluoropropene disclosed herein will be very similar to 2-BTP.

Bromotetrafluoropropenes are likely to be yet more effective than the bromotrifluoropropenes, because the substitution of a hydrogen atom for a fluorine atom typically increases the heat capacity of the molecule by 3-7%. In a similar fashion, substitution of a second hydrogen atom for a fluorine atom (thus resulting in a bromopentafluoropropene) typically increases the heat capacity of the molecule by a further 3-7%.

In summary, the overall suppression effectiveness from “physical contributions” of the bromotrifluoropropenes would be expected to be equivalent to 2-BTP, whereas the bromotetrafluoropropenes and bromopentafluoropropenes would be slightly more effective due their larger specific heats (i.e. heat absorption capacity).

Factors which have been linked to toxicity include the type of stereoisomer, position of bromination, symmetry of the compound, and degree of branching.

In cases where a compound has E and Z isomers, both are disclosed (“E/Z” denotes the E isomer and/or the Z isomer). In some embodiments, the compound as herein defined is a cis isomer (and optionally the composition is substantially free from the trans isomer). In some embodiments, the compound as herein defined is a trans isomer (and optionally the composition is substantially free from the cis isomer). In some embodiments, the compound as herein defined is an E isomer (and optionally the composition is substantially free from the Z isomer). In some embodiments, the compound as herein defined is a Z isomer (and optionally the composition is substantially free from the E isomer).

In some embodiments, the allylic C atom(s) (i.e. a C atom which is bonded to a C atom that forms a double bond with another C atom) are not bonded to a Br atom. In some embodiments, the Br atom(s) is bonded to a vinylic C atom (i.e. a C atom which forms a double bond with another C atom).

In some embodiments, the compound is a straight-chain compound. In some embodiments, the compound is a branched compound.

In some embodiments, the compound is symmetrical, i.e. it has an axis of symmetry. In some embodiments, the compound is asymmetrical.

In certain embodiments, the compositions and compounds according to the present disclosure compounds are tropodegradable, e.g. they degrade in the troposphere such that they do not enter the stratosphere, thus do not contribute significantly to ozone depletion or global warming.

The compounds may have an atmospheric lifetime of 1 year or less, e.g. 6 months or less, or one month or less.

The compounds may have an ozone depletion potential of less than 1, e.g. 0 to 0.5, 0 to 0.1, or 0 to 0.01.

The compounds may have a low global warming potential (GWP), e.g. 100 or lower, 10 or lower, or 1 or lower (relative to CO2). GWP is expressed in terms of the 100 year integrated time horizon (ITH).

The compound or composition of the present disclosure may be liquid at room temperature.

The compound or composition as herein described may have a boiling point in the range of 20 to 200° C., 20 to 150° C. or 30 to 100° C., e.g. 30 to 70 or 30 to 65° C. Boiling points referred to herein are at atmospheric pressure (101.325 kPa) unless otherwise stated.

The composition of the present disclosure may consist essentially of one or more non-PFAS hydrobromofluoroalkene(s). In some embodiments, the present disclosure provides non-PFAS hydrobromofluoroalkenes for use as a fire suppressant.

In some embodiments, the fire suppression composition can further comprise one or more additional components. The additional components may be selected from a gas (e.g. an inert gas), one or more additional fire suppressant compounds, propellants, odorants, or combinations thereof.

The total amount of additional components (i.e. components of the composition other than one or more non-PFAS hydrobromofluoroalkene(s)), if present, in the fire suppression composition may be up to 80 weight %, up to 60 weight %, up to 50 weight %, up to 20 weight %, up to 10 weight %, up to 5 weight % or up to 3 weight %, (e.g. from 0.1 weight % up to these limits) based on the total weight of the fire suppression composition. The remainder of the composition may be the non-PFAS hydrobromofluoroalkene(s), based on the total weight of the fire suppression composition, e.g. at least 20, at least 40, at least 50, at least 80, at least 90, at least 95, or at least 97 weight % of the fire suppression composition may be the one or more non-PFAS hydrobromofluoroalkene(s). In some aspects, the total amount of additional components present in the fire suppression composition may be up to 2 weight % or up to 1 weight %, e.g. 0.1 weight % to 2 weight % or 0.1 weight % to 1 weight % (e.g. at least 98, at least 99, e.g. 98-99.9 or 99-99.9 weight % of the fire suppression composition may be the non-PFAS hydrobromofluoroalkene(s)).

The additional components, if present, may be one or more gases, e.g. an inert gas, or a propellant. Examples of suitable gases include nitrogen, argon, helium and neon, and combinations thereof.

The optional gas may be present in an amount of up to 1 weight %, based on the total weight of the fire suppression composition. For example, the gas may be present in an amount of up to 0.9 weight %, up to 0.8 weight %, up to 0.7 weight %, up to 0.6 weight %, up to 0.5 weight %, up to 0.4 weight %, up to 0.3 weight %, up to 0.2 weight % or up to 0.1 weight %, based on the total weight of the fire suppression composition. If present, a lower limit for the gas may be 0.05 weight %.

The additional component, if present, may be one or more additional fire suppression agents, i.e. ones that are not a non-PFAS hydrobromofluoroalkene as herein described. In some embodiments, the additional fire suppression agent is not an alkene. Examples of suitable agents include nitrogen and carbon dioxide, and combinations thereof.

In some embodiments, the composition of the present disclosure comprises one or more non-PFAS hydrobromofluoroalkenes as herein described and a further fire suppression agent, e.g. one selected from nitrogen and carbon dioxide and combinations thereof. In some embodiments, the further fire suppression agent is carbon dioxide.

The total amount of additional (i.e. in addition to the non-PFAS hydrobromofluoroalkenes) fire suppression agents (e.g. nitrogen and/or carbon dioxide), if present, may be present in an amount of 20 to 80 weight %, e.g. 30 to 70 weight %, 40 to 60 weight % or around 50 weight %, based on the total weight of fire suppression agents in the composition (i.e. non-PFAS hydrobromofluoroalkene plus additional agent, e.g. CO2 and/or N2) or based on the total weight of the fire suppression composition. For example, the total amount of additional fire suppression agents present in the fire suppression composition may be up to 50 weight %, up to 30 weight %, up to 10 weight %, up to 8 weight %, up to 5 weight % or up to 3 weight % based on the total weight of the fire suppression composition. If present, a lower limit for the additional suppressant may be 0.1 weight %.

For example, the fire suppression composition of the present disclosure may comprise 20 to 80, 30 to 70, 40 to 60 or 50 weight % non-PFAS hydrobromofluoroalkene(s) and the remainder CO2 and/or N2. Additional (non-fire suppressant) components, e.g. as herein described, are optionally present.

In embodiments where the composition comprises more than one non-PFAS hydrobromofluoroalkene, the weight percentages of the non-PFAS hydrobromofluoroalkenes in the composition may approximately equal to each other.

In embodiments where the composition comprises more than one additional fire suppressant agent (i.e. other than the non-PFAS hydrobromofluoroalkene(s), e.g. additional agents such as CO2 and/or N2), the weight percentages of the additional fire suppressant agents in the composition may approximately equal to one another.

Some suitable blends of non-PFAS hydrobromofluoroalkenes and other fire suppressants, such as N₂ and/or CO₂, are outlined in the following table.

| Total Non-PFAS | Other fire suppressant, |
|---|---|
| hydrobromofluoroalkene | such as N₂ and/or CO₂ |
| weight % | (e.g. CO₂) weight % |
| 20 | 80 |
| 30 | 70 |
| 40 | 60 |
| 50 | 50 |
| 60 | 40 |
| 70 | 30 |
| 80 | 20 |

In some embodiments, the weight percentages are based on the total weight of the fire suppression composition.

In other embodiments, weight percentages are based on the total weight of fire suppression agents (i.e. the non-PFAS hydrobromofluoroalkenes plus additional fire suppression agents.) For example, up to 10 weight %, up to 8 weight %, up to 5 weight % or up to 3 weight % of the fire suppression composition may be something other than fire suppression agent, e.g. propellant and/or odorant.

The additional component, if present, can be an odorant. Examples of odorants include compounds which include one or more carbon-carbon double bonds, and/or compounds which are aromatic. The odorant compounds may further include a hydroxyl group, an iodine group, or both.

The odorant compound, if present, may be present in an amount of up to 1 weight % based on the total weight of the fire suppression composition. For example, the odorant may be present in an amount of up to 0.9 weight %, up to 0.8 weight %, up to 0.7 weight %, up to 0.6 weight %, up to 0.5 weight %, up to 0.4 weight %, up to 0.3 weight %, up to 0.2 weight % or up to 0.1 weight %, based on the total weight of the fire suppression composition. If present, a lower limit for the odorant may be 0.05 weight %.

The fire suppression composition of the present disclosure may consist of, or consist essentially of, the components described herein.

The fire suppression composition of the present disclosure may consist of, or consist essentially of, one or more non-PFAS hydrobromofluoroalkenes as herein described, optionally in combination with nitrogen and/or carbon dioxide.

In some embodiments, the composition as herein described is substantially free from per- and polyfluoroalkyl substances.

In some embodiments, the composition comprises less than 250 ppm in total, e.g. less than 100 ppb in total, e.g. less than 50 ppb in total, e.g. less than 25 ppb in total, per- and polyfluoroalkyl substances.

According to a further aspect, the present disclosure also provides a method for preparing a fire suppression composition, said method comprising combining one or more non-PFAS hydrobromofluoroalkenes as herein described, and one or more additional components as herein described. The relative quantities are as described herein.

According to a further aspect, the present disclosure also provides a fire suppression system or device, e.g. a fire extinguisher, fire suppression device, or storage device, wherein the system or device comprises a fire suppression composition or compound as herein described.

Disclosed is a fire suppression system or device comprising a fire suppression compound or composition as herein described, or the components thereof. The fire suppression system can comprise a fire suppression composition or compound herein described and a dispensing component (such as one or more nozzles that disperse the fire suppression composition). In an alternative aspect, the fire suppression system can contain: (i) two separate containers, wherein the first container comprises one or more non-PFAS hydrobromofluoroalkenes as herein described, and the second container comprises one or more additional components as herein described, and (ii) a combining and dispensing component which is configured to combine the contents of the separate containers to form a fire suppression composition as herein described, and then dispense said resulting fire suppression composition.

Also disclosed is a device, e.g. a fire extinguisher, fire suppression device, or storage device, comprising at least two separate containers, wherein the first container comprises one or more non-PFAS hydrobromofluoroalkenes as herein described and the second container comprises one or more additional components as herein described. The proportions of the non-PFAS hydrobromofluoroalkenes and the additional components are as described herein. The contents of the containers can be combined immediately prior to use to produce a fire suppression composition as herein described. As would be understood, the first and/or second container can comprise one or more additional components (e.g. one or more additional components as herein described) or any additional components can be stored in a further container or containers.

Also disclosed is a method for extinguishing or suppressing a fire comprising using (e.g. dispensing) a fire suppression composition or compound according to the present disclosure. For example, according to a further aspect, the present disclosure also provides a method for extinguishing or suppressing a fire, the method comprising the steps of: detecting a fire; and dispensing a fire suppression compound or composition according to the present disclosure.

Some of the hydrobromofluoroalkenes referred to herein are commercially available, e.g. from suppliers such as Apollo Scientific Ltd., American Custom Chemicals Corporation, Amadis Chemical Company Limited, Sant Cruz Biotechnology Inc. etc.

The compounds disclosed herein may be prepared using methods such as those discussed below.

### Allyl Bromoalkenes

By way of example, a method for preparing allyl bromoalkenes utilizes an allylic bromination where a suitable precursor (e.g. a non-PFAS fluoroalkene) is mixed with N-bromo-succinimide (NBS) in the presence of peroxide. The analogous scheme for producing 3-bromo-propene from propene as precursor is shown below:

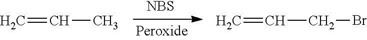

Examples of allyl bromoalkenes which can be made via this synthesis, together with their precursors are as follows:

| Precursor | Allyl bromoalkene |
|---|---|
| 1,2,3-trifluoropropene | CHBrFCF═CHF, i.e. 3-bromo-1,2,3-trifluoropropene |
| 1,3,3-trifluoropropene | CF₂BrCH═CHF, i.e. 3-bromo-1,3,3-trifluoropropene |
| 1,1,3-trifluoropropene | CBrFHCH═CF₂, 3-bromo-1,1,3-trifluoropropene |
| 1,2,3,3-tetrafluoropropene | CF₂BrCF═CHF, 3-bromo-1,2,3,3-tetrafluoropropene |
| 1,1,2,3-tetrafluoropropene | CHFBrCF═CF₂, 3-bromo-1,1,2,3-tetrafluoropropene |

An alternative synthesis route, exemplified for 3-bromo-1,1,2-trifluoropropene is set out below:

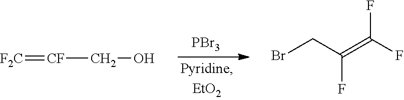

### Alkenyl Bromoalkenes

A method for preparing alkenyl bromoalkenes involves a two-step reaction to brominate an alcohol using first, perfluorobutanesulfonyl fluoride (PBSF) and second, lithium bromide. Another reaction converts the alkane to alkene using tetrabutylammonium chloride and potassium hydroxide yielding the desired product. An example of the reaction scheme is shown below, producing 1-bromo-2,3,3-trifluoropropene, starting from the precursor 2,2,3,3-tetrafluoropropan-1-ol.

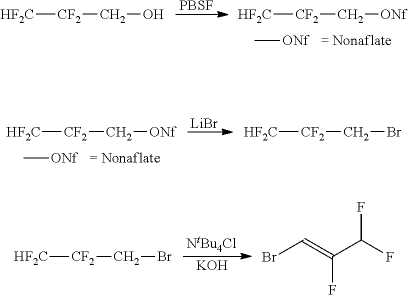

Examples of alkenyl bromoalkenes which can be made via this synthesis, together with their precursors are as follows:

| Precursor | Alkenyl bromoalkene |
|---|---|
| 1,1,1,3-tetrafluoropropan-2-ol | CFH₂CBr═CF₂, i.e. 2-bromo-1,1,3-trifluoropropene |
| 1,2,2,3,3-pentafluoropropan-1-ol | CF₂HCF═CBrF, i.e. 1-bromo-1,2,3,3-tetrafluoropropene |
| 1,1,1,3,3-pentafluoropropan-2-ol | CHF₂CBr═CF₂, i.e. 2-bromo-1,1,3,3-tetrafluoropropene |
| 1,1,3,3-tetrafluoropropan-2-ol | CF₂HCBr═CHF, i.e. 2-bromo-1,3,3-trifluoropropene |

1-bromo-1,3,3-trifluoropropene may be prepared via a hydro-halo-addition from the precursor 1,3,3-trifluoroprop-1-yne (potential suppliers: RR Scientific; J&H Chemical Co., Ltd.) and HBr.

Another alternative synthesis of allyl or alkenyl bromoalkenes can be accomplished by an olefin cross-metathesis reaction yielding ethylene and the desired product. For example, 1-bromo-1,2,3-trifluoropropene can be synthesised as set out in the scheme below by an olefin cross-metathesis reaction starting from 1-Bromo-1-fluoroethylene (potential suppliers: Alfa Chemistry; Enamine) and 2,3-Difluoroprop-1-ene (potential suppliers: RR Scientific; J&H Chemical Co., Ltd.) and yielding ethylene and 1-bromo-1,2,3-trifluoropropene.

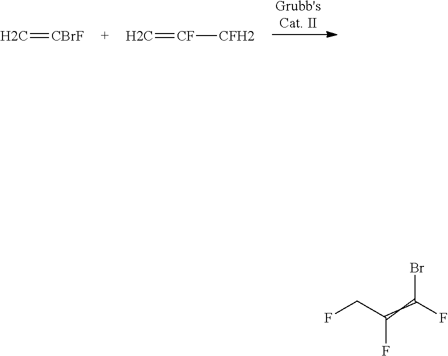

Suitable precursors are commercially available. For example, a precursor to 2-bromo-1,1,3-trifluoropropene can be obtained from AA BLOCKS, A2B Chem, and RR Scientific. A precursor to 2-bromo-1,3,3-trifluoropropene can be obtained from CymitQuimica, Enamine, and BenchChem. A precursor to 3-bromo-1,3,3-trifluoropropene can be obtained from BenchChem, RR Scientific, and J&H Chemical Co., Ltd. A precursor to 2-bromo-1,1,3,3-tetrafluoropropeneTet-2: can be obtained from J&H Chemical Co., Ltd; Enamine; and RR Scientific. A precursor to 3-bromo-1,1,2,3-tetrafluoropropene can be obtained from RR Scientific, Ambinter, and J&H Chemical Co. Ltd.

Regardless of the synthetic protocol, the compounds, including isomers and stereoisomers, can be isolated or purified using standard laboratory techniques such as separatory washing, distillation, and chromatographic separation.

In some embodiments, PFAS isomers are separated and removed from the composition. In some embodiments, cis, trans, E or Z isomers are separated and removed from the composition.

Characterization of the synthesised compounds is typically accomplished using gas chromatography-mass spectrometry or nuclear magnetic resonance (specifically 1H, 13C, 19F variants).

According to a further aspect, the present disclosure also provides a method of making a compound of formula CnX2n (e.g. where X=H, F, or Br) as herein described, e.g. an allyl or alkyl hydrobromofluoroalkene, said method comprising reacting a non-PFAS fluoroalkene with N-bromo-succinimide (NBS), e.g. in the presence of peroxide.

According to a further aspect, the present disclosure also provides a method of making a compound of formula CnX2n (e.g. where X=H, F, or Br) as herein described, e.g. an allyl or alkyl hydrobromofluoroalkene, said method comprising reacting a non-PFAS fluorinated alcohol with phosphorus tribromide to produce a hydrobromofluoroalkene.

According to a further aspect, the present disclosure also provides a method of making a compound of formula CₙX₂ₙ (e.g. where X=H, F, or Br) as herein described, e.g. an alkyl hydrobromofluoroalkene, said method comprising:
(i) reacting a partially fluorinated alcohol with perfluorobutanesulfonyl fluoride to produce a nonafluorobutanesulfonate analogue;
(ii) reacting the nonafluorobutanesulfonate with lithium bromide to produce a hydrobromofluoroalkane; and
(iii) converting the hydrobromofluoroalkane to a hydrobromofluoroalkene using tetrabutylammonium chloride and potassium hydroxide.

According to a further aspect, the present disclosure also provides a method of making a compound of formula CnX2n (e.g. where X=H, F, or Br) as herein described, said method comprising reacting a partially fluorinated alkyne with HBr to produce a hydrobromofluoroalkene. This method involves a hydro-halo-addition.

According to a further aspect, the present disclosure also provides a method of making a compound of formula CnX2n (e.g. where X=H, F, or Br) as herein described, said method comprising reacting partially brominated and/or fluorinated alkenes via olefin metathesis to produce a hydrobromofluoroalkene. This method may be viewed as an olefin cross-metathesis reaction.

Certain hydrobromofluoroalkenes of the present disclosure are novel. Thus, according to a further aspect, the present disclosure also provides a compound of formula CnX2n as herein described. The present disclosure also provides a fire suppression compound of formula CnX2n as herein described.

In certain embodiments, the Br atom(s) is bonded to a vinylic C atom (i.e. a C atom which forms a double bond with another C atom).

In certain embodiments, the compound is selected from the following:
2-bromo-1,1,3-trifluoropropene
3-bromo-1,2,3-trifluoropropene
1-bromo-1,2,3-trifluoropropene
3-bromo-1,1,3-trifluoropropene
1-bromo-1,2,3,3-tetrafluoropropene
2-bromo-1,1,3,3-tetrafluoropropene
3-bromo-1,1,2,3-tetrafluoropropene
3-bromo-1,2,3,3-tetrafluoropropene.

According to a further aspect, the present disclosure also provides use of a compound or composition as herein described as a fire suppressant.

The table below illustrates examples of some compositions according to the present disclosure. Additional (non-fire suppressant) components, e.g. as herein described, are optionally present.

| Blend | | | | |
|---|---|---|---|---|
| 1 | CFH₂CBr═CF₂ | CO₂ | — | — |
| | (50 wt. %) | (50 wt. %) | | |
| 2 | CF₂BrCH═CF₂ | CO₂ | — | — |
| | (50 wt. %) | (50 wt. %) | | |
| 3 | CHBrFCF═CHF | CO₂ | N₂ | — |
| | (60 wt. %) | (20 wt. %) | (20 wt. %) | |
| 4 | CBrFHCH═CF₂ | CO₂ | N₂ | — |
| | (60 wt. %) | (20 wt. %) | (20 wt. %) | |
| 5 | CFH₂CBr═CF₂ | CHBrFCF═CHF | CO₂ | — |
| | (30 wt. %) | (30 wt. %) | (40 wt. %) | |
| 6 | CF₂HCF═CHBr | CF₂HCF═CBrF | CO₂ | — |
| | (30 wt. %) | (30 wt. %) | (40 wt. %) | |
| 7 | CF₂HCF═CBrF | CHF₂CBr═CF₂ | CF₂BrCF═CHF | CO₂ |
| | (25 wt. %) | (25 wt. %) | (25 wt. %) | (25 wt. %) |
| 8 | CHBrFCF═CHF | CF₂BrCF═CH₂ | CH₂FCF═CBrF | CO₂ |
| | (25 wt. %) | (25 wt. %) | (25 wt. %) | (25 wt. %) |

The compositions and blends disclosed herein may be prepared by techniques known in the art. For example, the various components can be mixed in the desired proportions either before or during use.

The present disclosure will now be described further by the following non-limiting examples.

### EXAMPLES

### Example 1—Inerting Tests

### Testing Procedure

Testing is carried out against propane-air explosions in a 42 L sphere. The most explosive propane-air mixture is 4% propane in air. This concentration is therefore used to assess the relative performance of extinguishing agents and blends thereof.

The sphere is evacuated. Whilst monitoring the pressure transducer, propane is added to a pressure of 0.04 atm (4% in the final mix). The agent or agents to be tested are added at the desired concentration. Air is then added to raise the pressure in the sphere to 1.00 atm. A fan can then be used to ensure that all the gases are mixed homogeneously throughout the sphere. A spark is ignited using a centre point spark ignition and the pressure rise is monitored by a data logger. A pressure rise of 1psi or lower is designated as a pass.

The standards used for inerting testing are:
ASTM E2079-07—the standard test method for limiting oxidant concentration in gases and vapours;
BS EN 1839:2012—determination of explosion limits in gases and vapours;
BS EN 15967:2012—determination of maximum explosion pressure and the maximum rate of pressure rise of gases and vapours.

### Fractional Inerting Contribution

When assessing blends of components, the concept of fractional inerting contribution is used. This is defined as:

$$FIC = {\sum }_{i = 1}^{n} \frac{{C}_{i}}{{IC}_{i}}$$

Where Ci is the concentration of component i

And ICi is the inerting concentration of component i.

Thus, inerting should be attained when FIC=1 (i.e. the sum of individual concentrations has reached the overall required amount to achieve inerting). It therefore follows that if inerting is achieved at FIC less than 1, then the blend is more effective than the sum of its components. In other words, the blend is exhibiting synergy.

This test can be used to determine the inerting capability of the fire suppression compositions disclosed herein, e.g. non-PFAS hydrobromofluoroalkenes and their blends with other fire suppressants, such as N2 and/or CO2. The optimum blend may be determined by examining the limiting inerting concentration, and the FIC of that blend. The blend that gives the lowest FIC at the limiting inerting concentration is likely to be the most effective.

### Example 2—Cup Burner Testing

A cup burner is a relatively simple apparatus used to measure the extinguishing concentration of a fire extinguishing agent, or a blend of agents. The cup burner test is quick to perform, uses little extinguishing agent and gives repeatable results. It is regarded as an industry standard test for evaluating fire extinguishing agents.

A flame is established in a cup filled with liquid heptane fuel, situated in the centre of a glass tube. An airflow in the tube feeds the flame. Into this airflow the extinguishing agent is introduced, and its concentration gradually increased until the flame is extinguished. The agent concentration is measured, and the test can then be repeated.

### Example 3—Allyl Bromoalkene Synthesis (3-bromo-1,2,3-trifluoropropene)

1,2,3-trifluoropropene (0.02 mol) is dissolved in 100 mL CCl4. A solution of 0.02 mol of NBS, dissolved in 10 mL CCl4, is added dropwise to the solution followed by benzoyl peroxide (0.2 mmol). The solution is left to reflux overnight. The solvent is removed via rotavap, and the product washed with water via separation funnel. The sample (3-bromo-1,2,3-trifluoropropene) is collected checked for purity via GC-MS and NMR. Further purification can be done using distillation or column chromatography.

### Example 4—Allyl Bromoalkene Synthesis (3-bromo-1,1,2-trifluoropropene)

2,3,3-trifluoro-2-propen-1-ol (0.015 mol) is dissolved in ether with PBr₃ (0.33 mol equiv.) and 0.15 mL of pyridine. The mixture is left to stir overnight, warming to room temperature. The solution is dried via rotavap and washed with water in separatory funnel. The purity (3-bromo-1,1,2-trifluoropropene) is checked via GC-MS and NMR. Further purification can be done using distillation or column chromatography.

### Example 5—Alkenyl Bromoalkene Synthesis (2-bromo-1,1,3-trifluoropropene)

1,1,2,3-tetrafluoropropan-2-ol (0.01 mol) is added to 0.01 mol of PBSF in water. Potassium hydroxide is slowly added in excess and left to stir overnight. The reaction is washed in separation funnel with excess water, and the product collected. The resulting product is slowly added to 0.45 mol equiv. of LiBr in diglyme and refluxed overnight. The reaction is washed in separation funnel with excess water, and the product again collected. The resulting product is dropwise added to an aqueous solution of tetrabutylammonium chloride (0.04 mol equiv.) and KOH (2 mol. equiv.) and allowed to stir overnight. The reaction is washed in separatory funnel with excess water, and the product again collected. Purity (2-bromo-1,1,3-trifluoropropene) is checked by GC-MS and NMR. Further purification can be done using distillation or column chromatography.

### Example 6—Alkenyl Bromoalkene Synthesis (1-bromo-1,3,3-trifluoropropene)

An aqueous solution of 0.02 mol HBr is slowly added to 0.02 mol of 1,3,3-trifluoropropyne in water and is stirred for 2 hours. The resulting mixture is washed with water in a separation funnel and isolated. The purity (1-bromo-1,3,3-trifluoropropene) is quantified with GC-MS and NMR. Further purification can be done using distillation or column chromatography.

### Example 7—Alkenyl Bromoalkene Synthesis (1-bromo-1,2,3-trifluoropropene)

1-Bromo-1-fluoroethylene (0.005 mol) and 2,3-Difluoroprop-1-ene (0.005 mol) are added to a solution of dichloromethane and 5 mol % [1,3-bis-(2,4,6-trimethylphenyl)-2-imidazolidinylidene]dichloro(phenylmethylene)(tricyclohexylphosphino)ruthenium [Grubbs II Catalyst]. The solution is refluxed overnight, and then washed with water in a separation funnel and isolated. The purity (1-bromo-1,2,3-trifluoropropene) is quantified with GC-MS and NMR. Further purification can be done using distillation or column chromatography.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

References to the compound will be understood to apply also to the compounds in the compositions disclosed herein. Similarly, references to the compounds and compositions will be considered to apply to the methods and devices etc.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A fire suppression composition comprising:
a hydrobromofluoroalkene compound of formula CₙX₂ₙ, wherein:
n is an integer from 2 to 6;
each X is independently selected from the group consisting of Br, F, Cl and H, provided at least one X is Br; and
the compound does not contain —CF₃ or —CF₂—.

2. The composition of claim 1, where each X is independently selected from the group consisting of Br, F and H.

3. The composition of claim 1, where n=3 or 4.

4. The composition of claim 1 any preceding claim, where the number of F atoms is greater than or equal to the number of C atoms.

5. The composition of claim 1, further comprising:
one or more compounds selected from the group consisting of non-PFAS isomers of bromotrifluoropropene, bromotetrafluoropropene, bromotetrafluorobutene, bromopentafluorobutene, bromohexafluorobutene, and any combinations thereof.

6. The composition of claim 1, wherein the compound is selected from:
2-bromo-1, 1,3-trifluoropropene,
3-bromo-1,2,3-trifluoropropene,
1-bromo-1,2,3-trifluoropropene,
3-bromo-1, 1,3-trifluoropropene,
1-bromo-1,2,3,3-tetrafluoropropene,
2-bromo-1,1,3,3-tetrafluoropropene,
3-bromo-1,1,2,3-tetrafluoropropene,
3-bromo-1,2,3,3-tetrafluoropropene,
and any combinations thereof.

7. The composition of claim 1, further comprising an additional fire suppression agent.

8. The fire suppression composition of claim 7, wherein said additional fire suppression agent is present in an amount of 40 to 60 weight % of the total fire suppression composition.

9. The fire suppression composition of claim 7, where the additional fire suppression agent is selected from nitrogen and carbon dioxide, and combinations thereof.

10. The composition of claim 1, wherein the composition claim, which is substantially free from per-and polyfluoroalkyl substances.

11. A method for extinguishing or suppressing a fire, the method comprising the steps of:
detecting a fire; and
dispensing a fire suppression composition according to claim 1.

12. A fire suppression device comprising:
a fire suppression composition according to claim 1.

13. (canceled)

14. A fire suppression compound which is a hydrobromofluoroalkene compound of formula CₙX₂ₙ, wherein:
n is an integer from 2 to 6;
each X is independently selected from the group consisting of Br, F, Cl and H, provided at least one X is Br; and
the compound does not contain —CF₃ or —CF₂—.

15. The fire suppression compound according to claim 14, wherein said compound is:
2-bromo-1,1,3-trifluoropropene,
3-bromo-1,2,3-trifluoropropene,
1-bromo-1,2,3-trifluoropropene,
3-bromo-1, 1,3-trifluoropropene,
1-bromo-1,2,3,3-tetrafluoropropene,
2-bromo-1,1,3,3-tetrafluoropropene,
3-bromo-1,1,2,3-tetrafluoropropene, or
3-bromo-1,2,3,3-tetrafluoropropene.
